(19) United States
(12) Patent Application Publication
(10) Pub. No.: US 2010/0020879 A1
(43) Pub. Date: Jan. 28, 2010

(54) METHOD FOR DECODING A BLOCK OF A VIDEO IMAGE

(75) Inventors: Frederic Pasquier, Livre Sur Changeon (FR); Sylvain Fabre, Dinge (FR); Sebastien Fraleu, Noyal Sur Vilaine (FR)

Correspondence Address: Robert D. Shedd, Patent Operations;THOMSON Licensing LLC, P.O. Box 5312, Princeton, NJ, 08543-5312, US

(73) Assignee: THOMSON LICENSING

(21) Appl. No.: 12/448,441

(22) PCT Filed: Dec. 20, 2007
(86) PCT No.: PCT/EP2007/064291

§ 371 Date: Jun. 19, 2009

(30) Foreign Application Priority Data
Dec. 21, 2006 (FR) 0655837

(51) Int. Cl. H04N 7/26

(52) U.S. Cl. 375/240.16; 375/240.24; 375/E07.026; 375/E07.125

(57) ABSTRACT

The method is it comprises the following steps:
determination of the prediction window type related to the motion vector, non-outgoing or outgoing according to whether the prediction window is positioned entirely or in part inside the reference image.
if the prediction window is of outgoing type, filling a prediction buffer area having dimensions at least equal to that of the prediction window and positioned so as to include the prediction window, with the pixels of the reference image that are common to the prediction area and, for the remaining part, by copying, from said pixels, those located on the edge of the image,
calculating the predictor from the pixels of the buffer area located in the prediction window.

The applications relate to compression in H 264 or MPEG 4 part 10 format.

The invention relates to a method for decoding video data, more particularly for reconstructing a prediction window in inter mode, in the case of outgoing vectors.

The domain is that of video data compression. The video compression standard H264 or MPEG4 part 10, as well as other compression standards such as MPEG2, relies on reference images from which predictors enabling the reconstruction of the current image are recovered. These reference images have of course been previously decoded and are saved in memory, for example of DDR RAM (Double Data Rate Random Access Memory) type. This enables an image to be coded from previously decoded images, by encoding the difference in relation to an area of a reference image. Only this difference, called residue, is transmitted in the stream with the elements for identifying the reference image, the refldx index, and the components of motion vectors, MVx and MVy, enabling the area to be taken into account in this reference image to be found.

FIG. 1, which illustrates this dependence between the image to be decoded and the reference images previously decoded, shows a succession of video images from an image sequence, according to the displaying order, images of I, P or B type defined in the MPEG standard. In this example, the decoding of the image P₄ relies on the image INTRA I₀, this image being decodable in an autonomous way, thus without relying on a reference image. Thus, during the decoding of this image P₄, the decoder will search for areas of the image I₀ which will be used as predictors for decoding an area of the current image P₄. Each area will be indicated thanks to motion vectors transmitted in the stream.

Decoded image=predicted image+residues transmitted in the stream.

Similarly, image B of bidirectional type, B₂, will be decoded from images I₀ and P₄.

An image of I type is decoded in an autonomous way, that is, it doesn't rely on reference images. Each macroblock is decoded from its immediate neighbouring in this same image.

An image of P type is decoded from one or n reference images previously decoded but each block of the image will need only one predictor to be decoded, this predictor being defined by a motion vector, that is only one motion vector per block pointing towards a given reference image

A B type image is decoded from one or n reference images previously decoded but each block of the image can require 2 predictors to be decoded, that is 2 motion vectors per block pointing towards 1 or 2 given reference images. Then, the final predictor, which will be added to residues, will be obtained by realizing a weighted average of the 2 predictors retrieved from the information relating to the motion vectors.

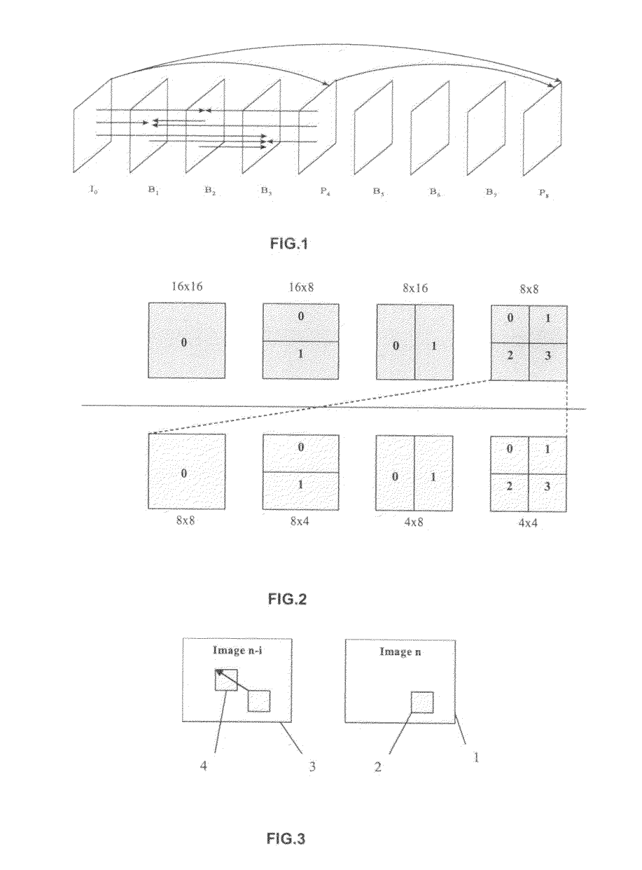

FIG. 2 shows the different possible partitions and sub-partitions for a macroblock of size 16 lines of 16 samples, for a coder using the H264 or MPEG4 part 10 standard. The first line corresponds to a horizontal and vertical cut of a 16×16 sized macroblock respectively into two 16×8 and 8×16 sized partitions or sub-macroblocks and a cut into four 8×8 sized sub-macroblocks. The second line corresponds to these same block or sub-partition cuts but at a lower level, for an 8×8 sized sub-macroblock. Each partition or sub-partition, according to the type of the macroblock to be processed, is associated with a vector towards a reference image in the case of a P type image. In the case of a B type image, each partition or sub-partition is associated with 1 or 2 vectors towards one or 2 reference image(s).

FIG. 3 illustrates the search for a predictor referenced 4 in a previous image n−1 referenced 3 for a current macroblock referenced 2 in a current image n referenced 1 in the case of a 16×16 partition, from a reference image index, refldx, and a motion vector.

The vectors transmitted in the stream have a ¼ pixel resolution, so it is necessary to realize an interpolation to ¼ of a pixel for the luminance in order to determine the final luminance predictor, in the case of the H264 standard. These vectors indicate the top left edge of the area to be interpolated.

The determination of the area to be interpolated in a reference image does not pose a particular problem if this area remains inside the reference image. However, the H264 standard enables the reference image to be sent in the stream of outgoing vectors. Each time the area pointed to by a vector is not entirely inside the image, the decoder should begin by reconstructing this area outside the reference image before providing it for the interpolation process.

The consequence of this constraint is to process differently the phase which consists in retrieving the area to be interpolated according to the nature of the prediction window defined by the motion vector, according to whether it is “outgoing” from the reference image, that is partially outside of the reference image, or not.

In a manner known in the prior art, the predictor construction process in the case of an outgoing window consists in a vertical, horizontal or oblique duplication of pixels located at the reference image border in order to get the input area of the interpolation process. Some examples are given below, the coordinates being referenced in the top left corner of the reference image for horizontal and vertical axes oriented respectively towards the right and towards the bottom:

case of an outgoing vector with the coordinates (x, −2) (0<x<image width)

In this example, the two first 16 pixel lines of the prediction window do not belong to the reference image. They have to be reconstructed from the 3^{rd} line which belongs to the upper edge of the image: duplication of this line 3.

It would have been the same if the vector was outgoing below the horizontal border of the image bottom. In this case, the last pixel line would have been vertically duplicated towards the bottom to get the final predictor.

case of an outgoing vector with the coordinates (−7,y) (0<y<image height)

In this example, the 7 first 16 pixel columns of the prediction window do not belong to the reference image. They have to be reconstructed from the 8^{th} column which belongs to the left edge of the reference image: duplication of this column 8.

One solution of the prior art for constructing the predictor consists in storing the reference images in a memory with a crown surrounding it. FIG. 4 shows such a solution. The reference image 7, for storage, is enlarged with a crown 5 which corresponds to a recopying of the pixels 6 at the edge of the image. This crown has for example a “thickness” of 1 macroblock, that is to say of 16 samples.

This solution is very costly in terms of memory size. For example for a high definition image, with a 1920×1080 resolution in 4:2:0 standard, the memory required for such a backup is of 380 macroblocks, or about 160 Kbytes and this for each reference image. As the H264 standard requires storing 4 reference images, the memory size required for this backup is in the order of 600 Kbytes, which is very penalizing, particularly for embedded systems.

In addition, the reconstruction of this crown should be realized in a systematic way, before the calculation of the interpolation vectors. However, for most images, the motion vectors use a prediction window inside the image, this reconstruction is then unnecessary. However, this construction has a cost in terms of the number execution cycles which can not be ignored. This is a critical aspect of real time video decoding systems where no cycle should be lost.

Likewise, the decoding circuit architecture is rendered more complex because of constraints related to this copying crown. The use of this crown has consequences on modules other than those related to the interpolation calculation. Hence, the module for displaying the decoded images, which is directly connected to the DDRAM memory for searching the areas to be displayed, should be able to display these images without the crown.

One purpose of the invention is to overcome the disadvantages described above. The object of the invention is a method for decoding a block of a video image, this block having been encoded according to a predictive mode, this mode encoding a block of residue corresponding to the difference between the current block and a prediction block or predictor whose position is defined in a reference image from a motion vector, characterized in that it carries out the following steps:
determining the type of prediction window related to the motion vector, either incoming or outgoing, according to whether the prediction window is entirely or partially positioned in the reference image,
if the prediction window is of the outgoing type, filling a prediction buffer area having dimensions at least equal to that of the prediction window and positioned so as to include the prediction window, with the pixels of the reference image that are common to the prediction area and, for the remaining part, by copying, from said pixels, those located on the edge of the image,
calculating the predictor from the pixels of the buffer area located in the prediction window.

According to a particular embodiment, the type of prediction window is defined from the initial coordinates of the motion vector, its components and the dimension of the block to which it is assigned.

According to a particular embodiment, the predictor calculation comprises a step of pixel interpolation in the prediction window.

According to a particular embodiment, the buffer area consists in 4 blocks, one block formed by pixels which are common to those of the reference image block to which the prediction window pixels belong, the 3 other blocks being obtained by copying pixels of this reference image block which are at the edge of the image. One of the 3 blocks can be obtained by copying the single pixel in a corner of the image.

According to a particular embodiment, an image block is a macroblock, a macroblock partition or a macroblock sub-partition. The size of the interpolation area depends on the size of the macroblock partition or sub-partition to which the motion vector is assigned.

According to a particular embodiment, the method uses the MPEG4 standard.

The invention relates also to a decoding device for implementing the method comprising a compressed data processing circuit, a memory connected to the processing circuit, characterized in that, when a prediction window is of the outgoing type, the memory creates a prediction buffer area formed by the prediction window pixels which belong to the reference image and a copy of pixels of this prediction window at the edge of the image.

Thanks to the invention, the predictor construction is carried out only in the case when the prediction window is outgoing. It is an ‘on-the-fly’ reconstruction, almost in real time, of the prediction window which corresponds to the only area pointed to by the vector.

Hence, the realization cost of the decoder is reduced due to a lower requirement in memory space. There is no potentially unnecessary memory consumption at the level of the storage area of reference images, for example when there is no outgoing vector.

The efficiency is improved, the operation time being reduced. The machine cycle consumption takes place only if necessary for reconstructing the predictor area to be interpolated.

The other decoding circuit modules are not concerned by this solution. It is not necessary to modify the displaying module to indicate a valid data area.

Other specific features and advantages of the invention will emerge clearly from the following description, provided as a non-restrictive example and referring to the annexed drawings wherein:

FIG. 1 shows, a succession of type I, P and B images in an image sequence,

FIG. 2 shows, a macroblock divided into partitions and sub-partitions,

FIG. 3 shows, a predictor in a reference image,

FIG. 4 shows, a prediction crown of the reference image according to the prior art,

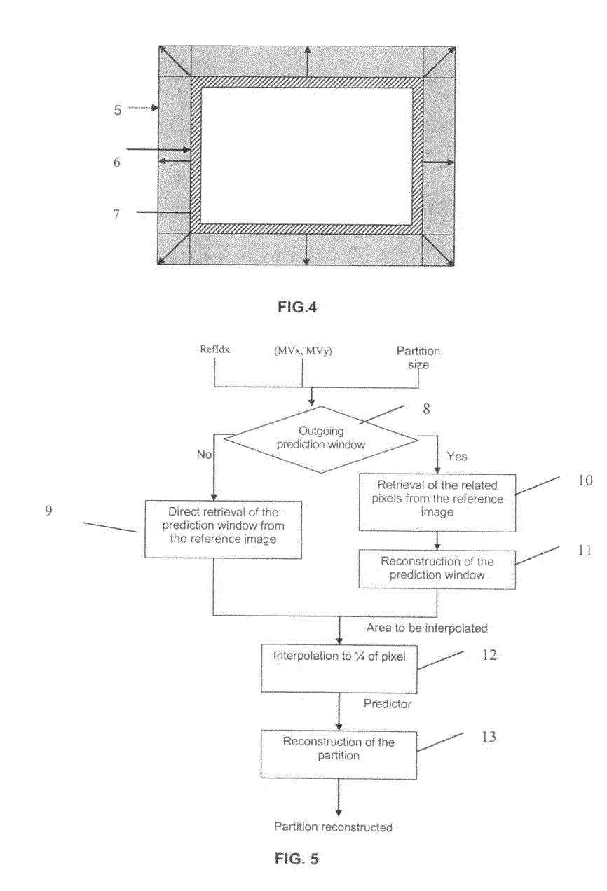

FIG. 5 shows, a flow chart of the method according to the invention,

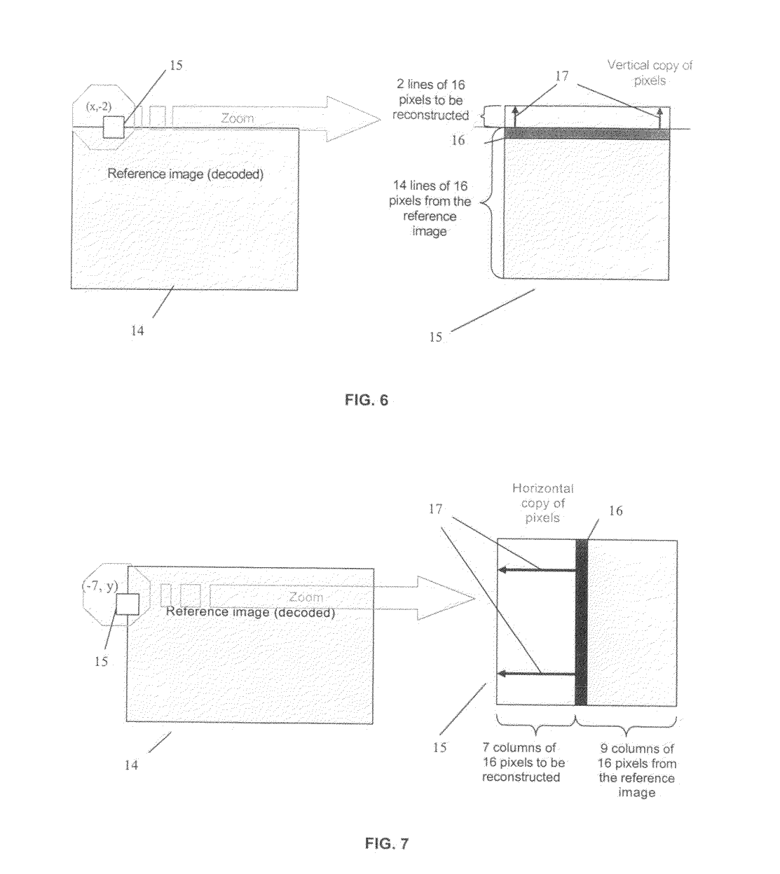

FIG. 6 shows, an example of prediction window for an outgoing vector at the top of the image,

FIG. 7 shows, an example of a prediction window for an outgoing vector at the left of the image,

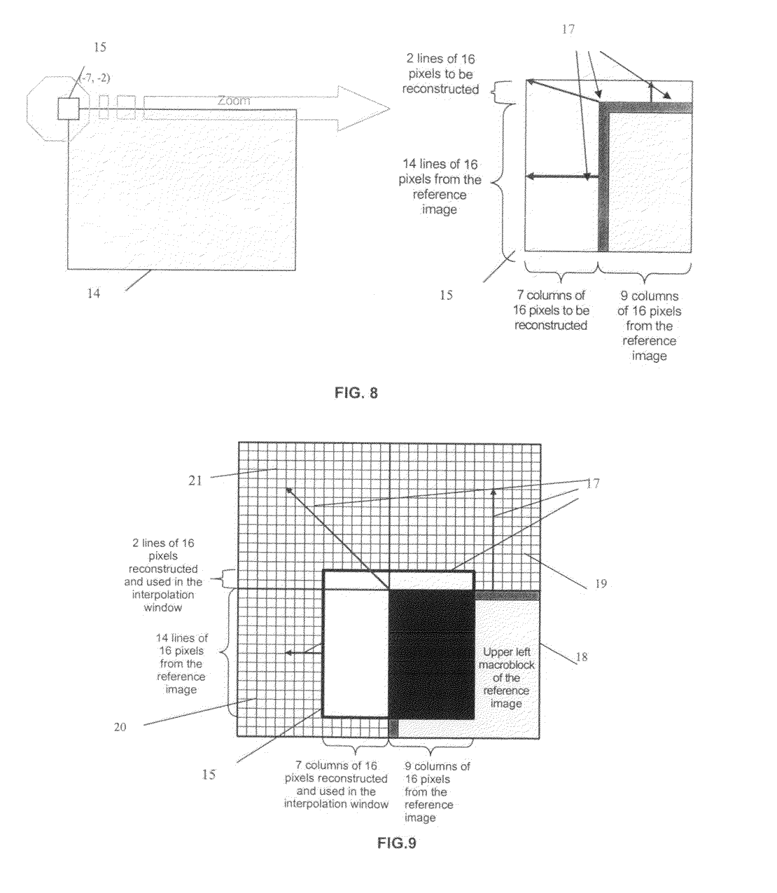

FIG. 8 shows, an example of a prediction window for an outgoing vector to the top left corner of the image,

FIG. 9 shows, a detailed view of the prediction window for an image corner,

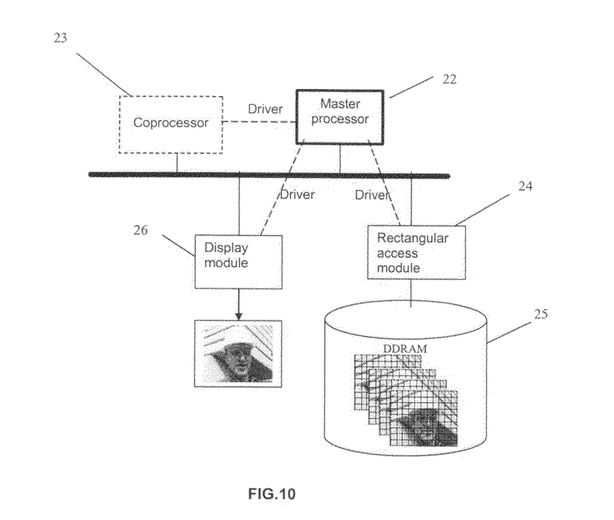

FIG. 10 shows, a decoding device.

FIG. 5 shows a flow chart of the method according to the invention. The different steps for decoding an inter type macroblock or block in a P type image are described.

The processing process receives, for each partition of a current macroblock in a current image, information relative to the partition size, the motion vector assigned, its coordinates MVx, MVy, the corresponding reference image, the refldx index.

A first step referenced 8 uses this information to determine if the motion vector is an outgoing vector of the reference image, that is to say if the second end of the motion vector, the first end being positioned at the top left corner of the collocated block of the current block or partition of the current image, has at least one of its coordinates which is negative or if its abscissa and/or ordinate has respectively a higher value than that of the pixels at the right edge of the image and that of the pixels at the bottom edge of the image. This in the standard frame, that is with the origin at the top left of the image and the axes oriented to the bottom right.

In the negative, the next step is step 9 which, in a standard way, realizes a direct retrieval of the prediction window from the reference image.

In the affirmative, the next steps are step 10 which realizes a retrieval of the related pixels from the reference image, then step 11 which realizes a reconstruction of the prediction window. This window is therefore filled with pixels retrieved from the reference image and, for the missing pixels, with a copy of pixels located at the image edge. This copy is explained later for the different cases giving the corners.

The step which succeeds step 9 or step 11 is step 12 which realizes an interpolation to the quarter of the pixel from the prediction window retrieved and possibly reconstructed. From this prediction window or interpolation window, an input area to the interpolation process is created which consists in a widening of the prediction window, by copying pixels at the window edge. For example, for a bi-dimensional filtering using a filter with 5 coefficients, the widening of the prediction window for the interpolation consists in adding 5 columns and lines, 2 columns at the left and 3 at the right, 2 lines at the top and 3 at the bottom of the window. A filter recommended by the H264 standard for an interpolation to ¼ of a pixel has 6 coefficients: 1, −5, 20, 20, −5, 1. It requires, for calculating a sub-partition predictor of dimensions 4×4, a 9×9 sized input area, and a 13×13 sized input area for a sub-partition of dimensions 8×8.

More generally, the input area of the interpolation process can be defined from the interpolation filter used and the size of the interpolation window. Hence, a digital filter with p coefficients requires, for calculating the predictor of an n×n sized block, an input area or processing area of dimensions n+(p−1) at least in the horizontal and vertical interpolation direction:

The predictor obtained after interpolation has the same dimensions as the current partition of the current image.

The following step 13 realizes the partition reconstruction by adding the decoded residue to the predictor, in order to provide the partition decoded or reconstructed.

FIG. 6 shows the case of filling a prediction window for an outgoing vector whose end has a negative ordinate, equal to −2.

In the reference image 14, the collocated block of the current block of the current image is moved from the motion vector to provide the “moved” block or prediction window 15 which is located at the upper edge of the image, partly outside the image. An enlargement of this prediction window, right part of the figure, shows that 2 upper lines are located outside the image, in compliance with the coordinates of the motion vector end. These lines are filled by doing vertical copies of the pixels 16 at the image edge, as indicated by the arrows 17.

FIG. 7 shows the case of an outgoing vector whose end has a negative abscissa, equal to −7. The “moved” block or prediction window 15 is located at the left edge of the reference image 14, partly outside the image. An enlargement of this prediction window, right part of the figure, shows that 7 columns on the left are located outside the image, in conformity with the coordinates of the motion vector end. These columns are filled by doing horizontal copies of the pixels 16 at the image edge, as indicated by the arrows 17.

FIG. 8 shows the case of an outgoing vector whose end has a negative abscissa, equal to −7, its negative ordinate equal to −2. The “moved” block or prediction window 15 is located at the left upper edge of the reference image 14, partly outside the image. An enlargement of this prediction window, right part of the figure, shows that 2 upper lines and 7 columns on the left are located outside the image, in conformity with the coordinates of the motion vector end. These lines and columns are filled by doing horizontal and vertical copies at the image edge. The 14 pixels at the corner which have no horizontal or vertical correspondence are obtained by copying the pixel at the corner belonging to the image. The arrows 17 indicate these copies.

To realize the step of reconstructing the prediction window, in the case of an outgoing prediction window, the method uses, in a DDRAM memory of the system, a single area. When a window is of “outgoing” type, an area or prediction buffer memory is filled, the memory area having a size of two macroblocks by two macroblocks containing the prediction window. The prediction buffer area is filled during the step 11 by the macrocblock(s) pixels of the reference image for which pixels are located in the prediction window and, for the remaining macroblock(s), by copying pixels belonging to the stored macroblock(s) of the reference image and which are located at the edge of the image to be enlarged. In the case where only one macroblock of the reference image is concerned, if the macroblock is not a corner macroblock, it is sufficient to store only a second macroblock in the buffer area, in addition to this first macroblock, the second macroblock being a copy of the line or column at the image edge of the first stored macroblock.

FIG. 9 illustrates this reconstruction step in the case of an outgoing vector for which the end has negative horizontal and vertical coordinates, for example −7 and −2, case of the upper left corner. The end of the motion vector having defined the location of the prediction window 15, the reference image macroblock 18 whose pixels belong to this prediction window 15 is identified and stored in the DDRAM memory. The pixels of this macroblock 15 at the image edge are copied, as indicated by the arrows 17, in the memory to generate three macroblocks 19, 20 and 21. The corner macroblock 21 is a copy of the only pixel located in the left upper corner of the image. The area to be interpolated is obtained by extracting from the 32×32 pixel sized area, the 16×16 pixel area corresponding to the prediction window 15 defined by the motion vector.

In the example, the prediction window is partially located on the top left macroblock of the reference image. Therefore, this macroblock is used to initialize the prediction buffer area by being the bottom right macroblock of this 32×32 area in DDRAM.

The invention also relates to a device for decoding a video stream implementing the decoding method previously described. FIG. 10 represents such a device.

A processor 22 handles the exchanges on the decoder internal bus. This bus is connected, through a rectangular access module 24, to a DDRAM type memory, referenced 25, which stores the reference images. This memory contains the video data relating to images reconstructed by the decoder, among which the reference images, which are also the images to be displayed. The rectangular access module enables only one area of an image to be retrieved, for example the predictors in the reference image before realizing the interpolation process. A displaying module 26 is connected to the bus and processes the video data to make them compatible with the display used during the viewing of the images, for example from a pointer indicating the beginning of an area to be displayed and from the image format to be displayed.

A coprocessor 23, connected to the coprocessor 22 and to the bus, can also be used to allow the acceleration of some tasks regularly realized on the pixels, for example the acceleration of functions such as the interpolation, the pixel propagation, etc.

In a standard way, the master processor 22 realizes, among other things, the image decoding operations, such as the variable length decoding, the inverse cosine transformation, the inverse quantization, the image reconstruction, the motion compensation, the intra or inter prediction, the interpolation, the management of the data storage in DDRAM memory, the displaying module control, etc.

An area of the DDRAM memory is initialized, in the case where a window is of “outgoing” type, by storing the macroblock(s) of the reference image whose pixels belong to the prediction window. The coprocessor fills the rest of the 32×32 pixel area by enlarging this initialized part in the appropriate directions. The reconstructed area to be interpolated is a 16×16 sub-part of the 32×32 area.

The rectangular access module allows, when a window is “outgoing” and then in the case where the predictor is, only for a part, inside the reference image, to read pixels from the prediction or interpolation window in the prediction buffer area comprising therefore pixels coming from the reference image but also, for the part outside the reference image, pixels obtained by copying those at the reference image edge.

The examples previously described are based on a 16×16 pixels size prediction window. Naturally, these prediction windows can have the size of a macroblock partition or sub-partition. The prediction buffer area can be related to the prediction window size and, so, have the dimensions of 4 partitions or sub-partitions if the motion vector relates to a macroblock partition or sub-partition. If the prediction window pixels belong only to one macroblock of the reference image which is not at the image corner, it is possible to reduce this prediction buffer area to this macroblock and to a second macroblock constructed by repeating the pixel line of the reference image macroblock which are at the image edge. If the prediction window pixels belong only to one block of the reference image which is not at the image corner, it is possible to reduce this prediction buffer area to this block and to a second block constructed by repeating the pixel line of the reference image block which are at the image edge.

Some examples have been given only for outgoing vectors. Naturally, the invention also relates to motion vectors inside the image but for which the prediction window is located, in part, outside the reference image.

The examples are based on a 16×16 pixel size interpolation window. It is possible to manage the interpolation window of a greater size without leaving the scope of the invention.

1. Method for decoding a block of a video image, this block having been encoded according to a predictive mode, this mode encoding a block of residue corresponding to the difference between the current block and a prediction block or predictor whose position is defined in a reference image from a motion vector, comprising the following steps:
determination of the prediction window type related to the motion vector, non-outgoing or outgoing according to whether the prediction window is positioned entirely or in part inside the reference image.
if the prediction window is of outgoing type, filling a prediction buffer area having dimensions at least equal to that of the prediction window and positioned so as to include the prediction window, with the pixels of the reference image that are common to the prediction area and, for the remaining part, by copying, from said pixels, those located on the edge of the image,
calculating the predictor from the pixels of the buffer area located in the prediction window.

2. Method according to claim 1, wherein the prediction window type is defined from the initial coordinates of the motion vector, its components and the dimensions of the block to which it is assigned.

3. Method according to claim 1, wherein the predictor calculation comprises a step of pixel interpolation (12) in the prediction window.

4. Method according to claim 1, wherein the buffer area consists of 4 blocks, one block formed by pixels which are common to those of the reference image block to which the prediction window pixels belong, the 3 other blocks being obtained by copying pixels of this reference image block which are at the edge of the image.

5. Method according to claim 4, wherein one of the 3 blocks is obtained by copying the only pixel at the image corner.

6. Method according to claim 1, wherein an image block is a macroblock, a macroblock partition or a macroblock sub-partition.

7. Method according to claim 6, wherein the size of the interpolation area depends on the size of a macroblock partition or sub-partition to which the motion vector is assigned.

8. Method according to claim 11, wherein it uses the MPEG4 standard.

9. Decoding device for implementing the method according to claim 1, comprising a compressed data processing circuit, a memory connected to the processing circuit, wherein, when a prediction window is of outgoing type, the memory includes a buffered prediction area formed by the prediction window pixels belonging to the reference image and a copy of pixels of this prediction window at the edge of the image.
